(19) United States
(12) Patent Application Publication
(10) Pub. No.: US 2003/0221974 A1
(43) Pub. Date: Dec. 4, 2003

(54) Electrolytic solution formulation for electropolishing process

(76) Inventors: Jia-Min Shieh, Yunlin (TW); Shih-Chieh Chang, Taipei (TW); Bau-Tong Dai, Hsinchu Hsien (TW); Ying-Hao Li, Hsinchu (TW); Kwo-Hung Shen, Junghe City (TW)

Correspondence Address: J.C. Patents, Inc., Suite 250, 4 Venture, Irvine, CA, 92618, US

(21) Appl. No.: 10/367,326

(22) Filed: Feb. 13, 2003

(30) Foreign Application Priority Data
Jun. 4, 2002 (TW) 91111935

(51) Int. Cl. B23H 3/08

(52) U.S. Cl. 205/677; 205/678

(57) ABSTRACT

An electrolytic solution formulation for an electropolishing process comprises at least an acid solution and an organic additive. The acid solution includes phosphoric acid or a mixture of phosphoric acid and sulfuric acid solutions, which can form a passivation layer on the surface of the metal layer. The additive comprises at least an acid group, wherein the diffusion of the organic additive is controlled in which a concentration gradient is formed in the opening of the metal layer. The electropolishing rate at the top of the opening is thereby faster than that at the bottom of the opening. The organic additive is selected from a monocarboxylic acid compound, a dicarboxylic acid compound, a tricarboxylic acid compound, a heterocyclic carboxylic acid compound or a sulfonic acid compound.

### CROSS-REFERENCE TO RELATED APPLICATION

This application claims the priority benefit of Taiwan application serial no. 91111935, filed on Jun. 4, 2002.

### BACKGROUND OF THE INVENTION

1. Field of Invention

The present invention is related to a semiconductor planarization process. More particularly, the present invention is related to an electrolytic solution formulation for an electropolishing process.

2. Description of Related Art

Among the various semiconductor manufacturing techniques, surface planarization is one important technique for high density photolithography. A planarized surface without variation in height prevents the scattering of an exposure light to effectively transfer a dense conductive line pattern. To provide a refined planarization for a wafer is thus an important issue in semiconductor device manufacturing. Even in recent years, chemical mechanical polishing (CMP) remains a popular method for wafer planarization in a semiconductor process. A major reason is because the chemical mechanical polishing technique is an anisotropic type of polishing. Beside being able to provide a global planarization for a wafer surface, chemical mechanical polishing is also applicable for the manufacturing of the horizontal and vertical metal interconnects of a damascene structure, the manufacturing of shallow trench isolation structures in the front end process, the manufacturing of advanced devices, the planarization of micro electronic systems and the manufacturing of flat screen monitors.

However, in practical application, problems, such as, pattern effect, remove selectivity, metal line dishing effect, scratch, oxide erosion and chemical mechanical polishing post-clean, etc., need to be addressed and overcome. Further, a new process is required for the manufacturing of the future 12 inch wafer and to accommodate the low stress demand of a low dielectric constant (low K) material. It is thus obvious that the chemical mechanical polishing technique faces a great challenge and a next generation planarization technique is desired to resolve the aforementioned problems.

Compared to a chemical mechanical polishing process, an electropolishing process (as in U.S. Pat. No. 6,056,864, WO 00/03426) can result with less scratch, less microparticles adhesion, less waste slurry (lower solvent cost), higher etching rate (high productivity). Further, no pressure is needed to apply on the substrate. Therefore, electropolishing is the newer alternative for planarizing a surface.

However, in a typical backend copper conductive line fabrication process, the copper layer, formed by electroplating, is highly nonplanar due to the presence of conductive line trenches. The nonplanarity affects the subsequent electropolishing process. Therefore, being able to improve the planarizing ability of an electropolishing process is important. In general, the planarizing ability provided by an electropolishing process is not only related to the electrolysis conditions, the electrolytic solution formulation for the electropolishing process is also an important factor. Therefore, in order to enhance the planarizing ability of an electropolishing process, an electrolytic solution that can provide a more desirable polishing ability is an important breakthrough.

### SUMMARY OF THE INVENTION

Accordingly, the present invention provides an electrolytic solution formulation for an electropolishing process, wherein the electropolishing rate difference on a nonplanar electroplated copper layer is improved to obtain a desirable planarized surface.

The present invention further provides an electrolytic solution formulation for an electropolishing process, wherein an additive is added to a concentrated phosphoric acid solution or a mixture of concentrated phosphoric acid and concentrate sulfuric acid solutions, and the diffusion of the additive in an opening is controlled to provide the electrolytic solution a more favorable planarizing ability.

In accordance to the present invention, an electropolishing solution formulation is provided. The electropolishing solution formulation comprises at least an acid solution and an organic additive, wherein the acid solution allows a passivation layer to form on the metal layer. The organic additive comprises at least an acid group, wherein a concentration gradient is formed in the opening of the metal layer such that the electropolishing rate near the top part of the metal layer is higher than the electropolishing rate at the bottom of the opening.

The diffusion of the organic additive of the present invention in an opening is controlled in which a concentration gradient is formed in the opening of the metal layer. The electropolishing rate at the top of the metal layer is faster than at the bottom of the metal layer to enhance the planarizing effect of the electropolishing process. The concentration of the organic additive is about 100 ppm to about 10000 ppm.

In accordance to the electrolytic solution formulation of the present invention, the acid solution includes phosphoric acid or a mixture of phosphoric acid and sulfuric acid solutions, wherein the concentration of the acid solution is about 50% to about 85%. The organic additive includes a moncarboxylic acid compound, a bicarboxylic acid compound, a tricarboxylic acid compound, and a sulfonic acid compound. The moncarboxylic acid compound includes C1 to C10 straight or branched chain monoaliphatic carboxylic acid and C7 to C10 monoaromatic carboxylic acid. The monoaliphatic carboxylic acid compound includes formic acid, acetic acid, propionic acid, butyric acid, isobutyric acid, valeric acid, isovaleric acid, caproic acid, enanthic acid, caprylic acid, pelargonic acid, capric acid, etc. The C7 to C10 monoaromatic carobxylic acid includes benzoic acid, phenyl acetic acid, toluic acid. The bicarboxylic acid includes C2 to C10 bialiphatic carboxylic acid and C8 to C10 biaromatic carboxylic acid. The bialiphatic carboxylic acid includes oxalic acid, malonic acid, succinic acid, glutaric acid, adipic acid, pimelic acid, suberic acid, azelaic acid, sebacic acid, etc. The C8 to C10 biaromatic carobxylic acid includes phthalic acid. The tricarboxylic acid includes C4 to C10 trialiphatic carboxylic acid and C9 to C10 triaromatic carboxylic acid. The heterocylic ring carboxylic acid compound includes, for example, bihydroxynitrobenzoic acid. Sulfonic acid compound includes benzene sulfonic acid, toluene sulfonic acid, etc. Further, the moncarboxylic acid compound, the bicarboxylic acid compound, tricarboxylic acid compound, heterocyclic ring carboxylic acid compound and sulfonic acid compound can further comprise 1 to 3 hydroxy groups. The hydroxycarobxylic acid compound includes, for example, citric acid, hydroxyacetic acid, hydroxypropionic acid, hydroxysuccinic acid, dihydroxysuccinic acid. When the organic additive is citric acid, benzoic acid or bihydroxynitrobenzoic acid, the concentration of the organic additive is about 500 ppm to 2500 ppm, preferably between 750 ppm to 1500 ppm. When the organic additive is oxalic acid or benzene sulfonic acid, the concentration of the organic additive is about 2000 ppm to 8000 ppm, preferably between 4000 ppm to 6500 ppm.

Using the electrolytic solution formulation of the present invention to perform an electropolishing process, the concentration of the organic additive is within the range, wherein a concentration gradient is generated at the wafer surface to be electropolished. The organic additive has to be able to influence the pH value (acid-base value) and the conductivity of the electrolytic solution and be able to generate a passivation layer on the metal surface. The electropolishing rate difference (electropolishing rate is higher at the top of the metal opening than at the bottom of the metal opening) on a nonplanar metal layer is thus enhanced. The planarization efficiency of an electropolishing process is thereby increased.

Further, according to the present invention, the amount of the additive added to the electropolishing solution formulation is minimal. Therefore, a copper conductive line is planarized using an electropolishing technique without inducing dishing or scratch to the metal conductive line or overpolishing the insulation layer of the copper plug.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic, cross-sectional view of a damascene structure according to one aspect of the present invention;

FIG. 2 is diagram illustrating the changes in pH and conductivity as a function of the concentration of citric acid; and

FIG. 3 is diagram illustrating the planarization efficiency and the step height reduction as a function of the concentration of citric acid.

### DESCRIPTION OF THE PREFERRED EMBODIMENTS

According to the present invention, an organic additive is added to an electropolishing electrolytic solution, wherein the organic additive can affect the pH and the conductivity of the electrolytic solution (acid-base value), and can generate a passivation layer on the metal surface. Planarization is achieved simply by relying on the electropolishing rate difference generated by the local nonplanar region on the metal surface.

The electrolytic solution formulation of the present invention comprises at least an acid solution that can form a passivation layer and an organic additive, wherein the acid solution includes, for example, a concentrated phosphoric acid solution or a mixture of concentrated phosphoric acid solution and concentrated sulfuric acid solutions.

The organic additive includes a moncarboxylic acid compound, a bicarboxylic acid compound, a tricarboxylic acid compound, and a sulfonic acid compound. The moncarboxylic acid compound includes C1 to C10 straight or branched chain monoaliphatic carboxylic acid and C7 to C10 monoaromatic carboxylic acid. The monoaliphatic carboxylic acid compound includes formic acid, acetic acid, propionic acid, butyric acid, isobutyric acid, valeric acid, isovaleric acid, caproic acid, enanthic acid, caprylic acid, pelargonic acid, capric acid, etc. The C7 to C10 monoaromatic carobxylic acid includes benzoic acid, phenyl acetic acid, toluic acid. The bicarboxylic acid includes C2 to C10 bialiphatic carboxylic acid and C8 to C10 biaromatic carboxylic acid. The bialiphatic carboxylic acid includes oxalic acid, malonic acid, succinic acid, glutaric acid, adipic acid, pimelic acid, suberic acid, azelaic acid, sebacic acid, etc. The C8 to C10 biaromatic carobxylic acid includes phthalic acid. The tricarboxylic acid includes C4 to C10 trialiphatic carboxylic acid and C9 to C10 triaromatic carboxylic acid. The heterocylic ring carboxylic acid compound includes, for example, bihydroxynitrobenzoic acid. Sulfonic acid compound includes benzene sulfonic acid, toluene sulfonic acid, etc. Further, the moncarboxylic acid compound, the bicarboxylic acid compound, tricarboxylic acid compound, heterocyclic ring carboxylic acid compound and sulfonic acid compound can further comprise 1 to 3 hydroxy groups. The hydroxycarobxylic acid compound comprises, for example, citric acid, hydroxyacetic acid, hydroxypropionic acid, hydroxysuccinic acid, dihydroxysuccinic acid.

Further, the diffusion of the organic additive is controlled, the planarizing ability of the electropolishing solution is enhanced. Since the electropolishing rate of the metal layer is related to the pH of the electrolytic solution, by adding an organic additive to the electrolytic solution, the pH value of the electrolytic solution is lower to increase the electropolishing rate of the electrolytic solution. Further, the velocity of metal ions is related to the conductivity of the electropolishing solution. Therefore, by adding an organic additive to the electropolishing solution to increase the conductivity of the electropolishing solution, the velocity of the metal ions is increased. Further, the concentration of the organic additive is gradated in the opening in the metal layer, wherein the organic additive at the top of the opening is more concentrated than at the bottom. Therefore, the metal layer at the bottom of the opening is removed at a slower rate during the electropolishing process than at the top of the opening to enhance the planarizing ability of the electropolishing process.

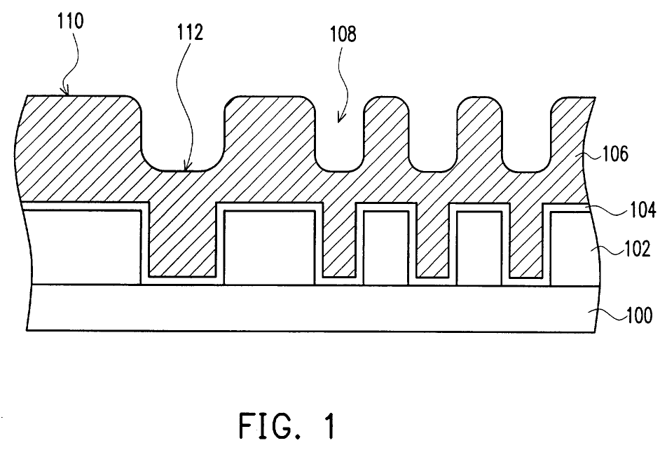

To better illustrate the features of the present invention, the effect of the concentration of the organic additive on pH, conductivity, step height reduction and planarization efficiency (PE) of the electropolishing solution are evaluated using citric acid in various concentrations as an example for the organic additive. The above electropolishing solution samples are used to perform an electropolishing process on a copper layer of a damascene structure as shown in FIG. 1.

Referring to FIG. 1, a semiconductor substrate 100 is provided. This substrate 100 comprises a dielectric layer 102 having a plurality of openings formed therein, a barrier layer 104 and a metal layer 106 sequentially formed thereon. The barrier layer 104 and the metal layer 106 fill the opening. Further, the metal layer 106 comprises a nonplanar topography, wherein the metal layer 106 is, for example, copper.

Thereafter, the electrolytic solution formulation of the present invention is used to perform electropolishing on the aforementioned damascene structure. Since the diffusion of organic additive (citric acid) is controlled, the concentration of organic additive (citric acid) is gradated inside the opening 108 of the metal layer 106. The organic additive is more concentrated at the top 110 of the opening 108 than at the bottom 112. Therefore, the metal layer 106 at the top 110 of the opening 108 is being removed at a faster rate than at the bottom 112 during an electropolishing process to increase the planarizing ability of the electropolishing process.

In accordance to the aforementioned embodiment of the present invention, citric acid is used as an example for the organic additive, the concentrations of the various components in the electropolishing solution formulation are summarized as follow:

concentration of phosphoric acid is between about 50% to 85%.

concentration of the organic additive (citric acid) is about 100 ppm to about 10000 ppm.

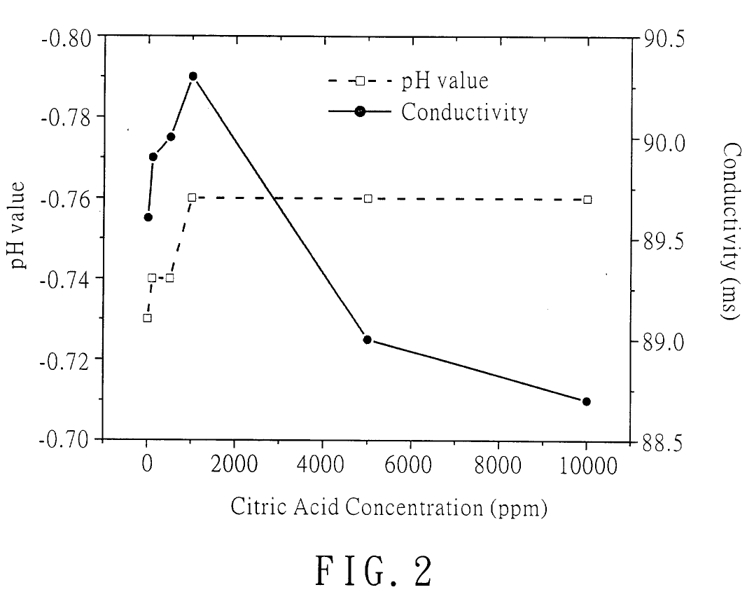

Referring to FIG. 2, FIG. 2 illustrates the changes in pH and conductivity as a function of the concentration of citric acid, wherein the symbol “--•--” represents conductivity, and the symbol “--□--” represents pH. As shown in FIG. 2, the pH value of the electropolishing electrolytic solution decreases to a critical value as the concentration of the organic additive increases. The conductivity of the electropolishing electrolytic solution increases to a critical value and then decreases as the concentration of the organic additive increases. For example, the electropolishing electrolytic solution without adding the organic additive of the present invention (additive concentration=0 ppm), the pH value is about −0.73 and the conductivity is about 89.7 mS. After adding the additive of the present invention to the electropolishing electrolytic solution (additive concentration=1000 ppm), the pH value is about −0.76 and the conductivity is about 90.3 mS. Therefore, adding the organic additive of the present invention to the electropolishing electrolytic solution can lower the pH and increase the conductivity of the electropolishing electrolytic solution. The copper electropolishing rate and the moving speed of copper ions are thus increased.

The planarization efficiency of electropolishing can be calculated according to the following formula:

PE=[1−(down/up)]×100%

Down: the height difference of the metal layer at the bottom of the opening before and after electropolishing

Up: the height difference of the metal layer at the top of the opening before and after electropolishing.

The step height reduction value can be calculated according to the following formula:

Step height reduction value=(up−down).

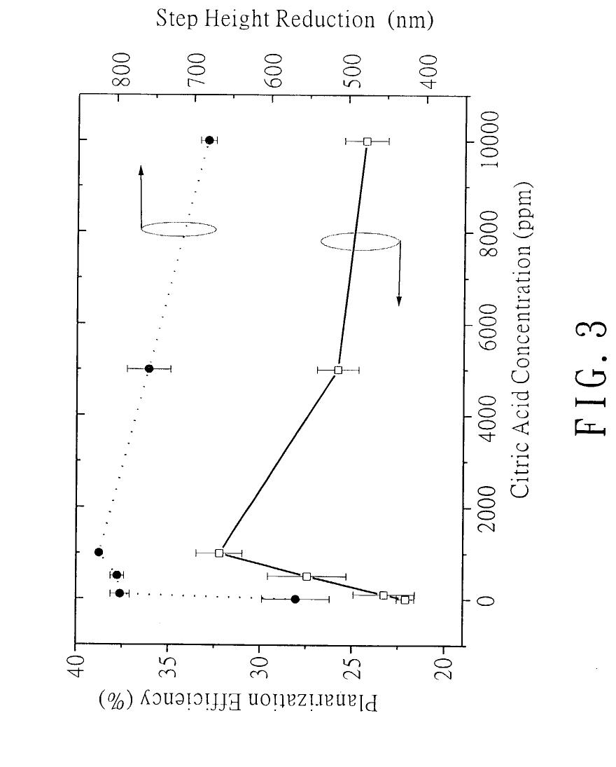

Referring to FIG. 3, FIG. 3 illustrates the planarization efficiency and step height reduction as a function of the citric acid concentration, wherein the symbol “--•--” represents step height reduction and the symbol “--□--” represents planarization efficiency (PE). As shown in FIG. 3, the planarization efficiency (PE) of the electropolishing electrolytic solution increases as the concentration of organic additive increases to a critical value and then decreases. The step height reduction of the electropolishing electrolytic solution increases as the concentration of the organic additive increases to a critical value and then decreases. For example, before adding the organic additive to the electropolishing electrolytic solution (organic concentration=0 ppm), the planarization efficiency is about 22% and the step height reduction is about 560 nm. After adding the organic additive to the electropolishing electrolytic solution (organic concentration=1000 ppm), the planarization efficiency is about 32% and the step height reduction is about 815 nm. Therefore, adding an additive of the present invention to the copper electrolytic solution increases both the planarization efficiency and the step height reduction, and enhances the planarizing ability of the copper electropolishing process.

Based on the results shown in FIG. 2 and 3, by adding the organic additive of the present invention to an electropolishing solution, the planarizing ability of the electropolishing process is increased.

Further, as shown in Table 1, when citric acid, acetic acid, oxalic acid, benzoic acid, bihydroxynitro benzoic acid and benzene sulfonic acid are used as additive to the copper electropolishing solution, desirable planarizing effects are also resulted.

TABLE 1

| | Additive | Planarization |
|---|---|---|
| Additive | Concentration (ppm) | Efficiency (PE %) |
| None | 0 | 22% |
| Citric Acid | 1000 | 32% |
| Acetic Acid | 10000 | 33% |
| Oxalic Acid | 5000 | 31% |
| Benzoic Acid | 1000 | 31.5% |
| Bihydroxynitro- | 1000 | 33% |
| benzoic acid | | |
| Benzene Sulfonic | 5000 | 30.5% |

Accordingly, when the organic additive is citric acid, benzoic acid or bihydroxynitrobenzoic acid, the additive concentration is preferably between about 500 ppm and about 2500 ppm, preferably between 750 ppm and 1500 ppm. When the organic additive is oxalic acid or benzene sulfonic acid, the additive concentration is about 2000 ppm to about 8000 ppm, preferably between 4000 ppm to about 6500 ppm.

In accordance to the aforementioned embodiment of the present invention, using the electrolytic solution formulation of the present invention to perform an electropolishing process, the electropolishing rate difference on a nonplanar metal layer is increased (the electropolishing rate is higher at the top of the metal layer opening than at the bottom of the metal layer opening). The planarizing effect of the electropolishing process is enhanced. This is because the electrolytic solution formulation for an electropolishing process of the present invention further includes an organic additive that can lower the pH value of the electropolishing solution, and can increase the conductivity of the electropolishing solution, the planarization efficiency and the step height reduction.

Moreover, in accordance to the present invention, only a minimal amount of the organic additive is added to the electropolishing solution formulation. The planarization of a copper conductive line using the electropolishing process of the present invention can already result with a more desirable planarizing effect without inducing dishing or scratch to the copper plug, and overetching of the insulation layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrolytic solution formulation for an electropolishing process, comprising:
an acid solution, wherein a passivation layer is formed on a surface of a metal layer by the acid solution; and
an organic additive, wherein the organic additive comprises at least an acid group, and a concentration of the organic additive is gradated in an opening of the metal layer to provide a higher electropolishing rate at a top of the opening than at a bottom of the opening.

2. The formulation of claim 1, wherein the metal layer comprises copper.

3. The formulation of claim 1, wherein the acid solution includes phosphoric acid.

4. The formulation of claim 1, wherein the acid solution includes a mixture solution of phosphoric acid and sulfuric acid solutions.

5. The formulation of claim 1, wherein a concentration of the acid solution is about 50% to about 85%.

6. The formulation of claim 1, wherein the organic additive is selected from the group consisting of a monocarboxylic acid compound, a bicarboxylic acid compound, a tricarboxylic acid compound, a heterocyclic carboxylic acid compound and a sulfonic acid compound.

7. The formulation of claim 6, wherein the monocarboxylic acid compound is selected from the group consisting of a monoaliphatic carboxylic acid compound having 1 to 10 carbon atoms and a monoaromatic carboxylic acid compound having 7 to 10 carbon atoms.

8. The formulation of claim 6, wherein the bicarboxylic acid compound is selected from the group consisting of a bialiphatic carboxylic acid compound having 2 to 10 carbon atoms and a biaromatic carboxylic acid compound having 8 to 10 carbon atoms.

9. The formulation of claim 6, wherein the tricarboxylic acid compound is selected from the group consisting of a trialiphatic carboxylic acid compound having 4 to 10 carbon atoms and a triaromatic carboxylic acid compound having 9 to 10 carbon atoms.

10. The formulation of claim 6, wherein the heterocyclic carboxylic acid compound comprises a bihydroxynitrobenzoic acid compound.

11. The formulation of claim 6, wherein the sulfonic acid compound includes a benzene sulfonic acid compound.

12. The formulation of claim 6, wherein the sulfonic acid compound includes a toluene sulfonic acid compound.

13. The formulation of claim 6, wherein the monocarboxylic acid compound, the bicarboxylic acid compound, the tricarboxylic acid compound, the heterocyclic carboxylic acid compound and the sulfonic acid compound are formed with one, two or three hydroxy groups.

14. The formulation of claim 1, wherein the organic additive is selected from the group consisting of citric acid, benzoic acid and bihydroxynitrobenzoic acid.

15. The formulation of claim 14, wherein the concentration of the organic additive is about 500 ppm to about 2500 ppm.

16. The formulation of claim 14, wherein the concentration of the organic additive is about 750 ppm to about 1500 ppm.

17. The formulation of claim 1, wherein the organic additive is selected from the group consisting of oxalic acid and benzene sulfonic acid.

18. The formulation of claim 17, where the concentration of the organic additive is about 2000 ppm to about 8000 ppm.

19. The formulation of claim 17, wherein the concentration of the organic additive is about 4000 ppm to about 6500 ppm.
